(19) United States
(12) Patent Application Publication
(10) Pub. No.: US 2007/0014273 A1
(43) Pub. Date: Jan. 18, 2007

(54) Method, device and computer readable medium for dynamically updating transmission charactaristics

(76) Inventors: Yefim Kuperschmidt, Or Yehuda (IL); Gadi Shor, Ramat Hachayal (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/181,618

(22) Filed: Jul. 13, 2005

(51) Int. Cl. H04B 7/212

(52) U.S. Cl. 370/347; 370/394

(57) ABSTRACT

A method for dynamically updating transmission characteristics, the method includes: evaluating at least one transmission characteristic in response to a reception of at least one information frame being transmitted over an ultra wideband wireless medium; and transmitting link feedback information and acknowledgement information in response to the reception of the at least one information frame. A device that includes: a receiver adapted to evaluate at least one transmission characteristic in response to a reception of at least one information frame being transmitted over an ultra wideband wireless medium; and transmitter adapted to transmit link feedback information and acknowledgement information in response to the reception of the at least one information frame. A computer readable medium having code embodied therein for causing an electronic device to perform the stages of: evaluating at least one transmission characteristic in response to a reception of at least one information frame being transmitted over an ultra wideband wireless medium; and transmitting link feedback information and acknowledgement information in response to the reception of the at least one information frame.

### FIELD OF THE INVENTION

The invention relates to methods, devices and computer readable medium for dynamically updating transmission characteristics especially in an ultra wideband wireless network.

### BACKGROUND OF THE INVENTION

Recent developments in telecommunication and semiconductor technologies facilitate the transfer of growing amounts of information over wireless networks.

Short-range ultra wideband wireless networks are being developed in order to allow wireless transmission of vast amounts of information between various devices.

Some of short-range ultra wideband wireless networks are characterized by a distributed architecture in which devices exchange information without being controlled by a central host or a base station.

FIG. 1 is a schematic illustration of an ultra wideband wireless network (also referred to as personal access network) 10 that includes first till fifth devices A-E 11-15.

Ultra wideband wireless network (hereinafter network) 10 uses time division multiple access (TDMA) techniques in order to allow its devices to share a single channel.

FIG. 2 illustrates a typical TDMA frame 30. TDMA frame 30 is also referred to as a super-frame. It includes multiple time-slots, such as beacon slots 14 and media access slots. The media access slots include distributed reservation protocol (DRP) slots 36 and prioritized contention access (PCA) slots 38. PCA slots are also referred to as PCA periods. DRP slots are also referred to as DRP periods. The TDMA frame is also referred to as super frame.

The beacon slots are used to synchronize devices to the TDMA frame 30. A typical beacon frame includes information that identifies the transmitting device. It also may include timing information representative of the start time of the TDMA frame 30.

The DRP slots 36 are coordinated between devices that belong to the same network and allow devices to reserve these slots in advance. During the PCA slots 38 devices that belong to the network compete for access based upon their transmission priority. It is noted that the allocation of media access time slots is dynamic and can change from one TDMA frame to another.

Typically, transmissions from devices during PCA slots are assigned by applying a carrier sense multiple access with collision avoidance (CSMA/CA) scheme. If a device requests to transmit over a wireless medium it has to check if the wireless medium is idle. If the wireless medium is idle, the device has to wait a random backoff period. This random backoff time is selected from a contention window that has a length that is related to the priority of the device. For higher-priority devices the contention window is shorter.

The transmission process is usually quite complex and includes many operations such as but not limited to forward correction encoding, interleaving, modulating and the like. A receiver must reverse the procedures applied by the transmitter.

In order to increase the reliability of transmissions devices are allowed to send an acknowledgment frame, that indicates that previously transmitted frames or group of frames were successfully received. The former is known as immediate acknowledge while the latter is known as burst acknowledge.

Ultra wideband networks use simultaneously multiple carrier signals to convey information over an ultra wideband wireless medium. The characteristic of that medium dynamically change. This change can be attributed to relative movement of the devices of the network and/or to relative movement of various objects within the environment of the devices. In addition additional changes can result from temperature changes, humidity changes and the like. Various phenomena such as but not limited to multi-path, can be significant at a certain moment and be of less significant in another moment.

Various methods for reducing the noise in ultra wideband receivers were developed. Some are illustrated in U.S. patent application 2003/0108133 of Richards and PCT patent application publication number WO 01/93519A1, which are incorporated herein by reference.

These changes may require to alter various transmission characteristics such as bit rate, transmission power level and the like.

There is a need to dynamically update transmission characteristics.

### SUMMARY OF THE INVENTION

A method for dynamically updating transmission characteristics, the method includes: evaluating at least one transmission characteristic in response to a reception of at least one information frame being transmitted over an ultra wideband wireless medium; and transmitting link feedback information and acknowledgement information in response to the reception of the at least one information frame.

A device that includes: a receiver adapted to evaluate at least one transmission characteristic in response to a reception of at least one information frame being transmitted over an ultra wideband wireless medium; and transmitter adapted to transmit link feedback information and acknowledgement information in response to the reception of the at least one information frame.

A computer readable medium having code embodied therein for causing an electronic device to perform the stages of: evaluating at least one transmission characteristic in response to a reception of at least one information frame being transmitted over an ultra wideband wireless medium; and transmitting link feedback information and acknowledgement information in response to the reception of the at least one information frame.

### BRIEF DESCRIPTION OF THE DRAWINGS

The present invention will be understood and appreciated more fully from the following detailed description taken in conjunction with the drawings in which:

FIG. 1 is a schematic illustration of a ultra wideband wireless network;

FIG. 2 illustrates a typical TDMA frame;

FIGS. 3-4 illustrate information frames, according to various embodiments of the invention;

FIGS. 5-7 illustrate various frame sequences, according to various embodiments of the invention;

FIGS. 8-10 illustrate various portions of a device capable of wireless transmission, according to various embodiments of the invention; and

FIG. 11 is a flow chart of a method for dynamically updating transmission characteristics, according to an embodiment of the invention.

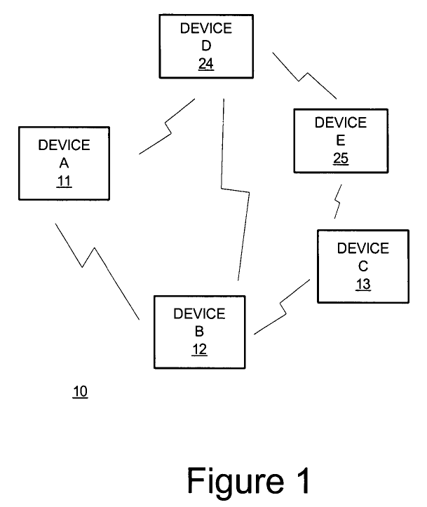

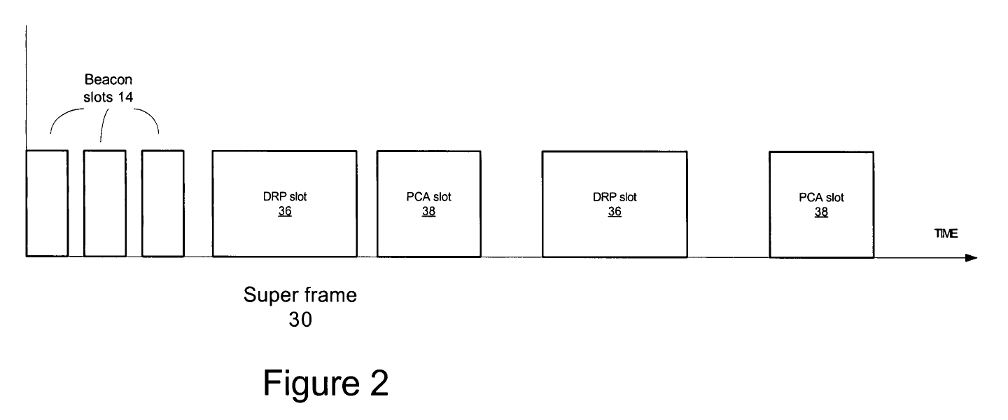

### DETAILED DESCRIPTION OF THE DRAWINGS

The following description related to wireless ultra wideband networks that utilize a distributed media access control scheme. In these networks there is no central media access controller, but rather various devices of the network participate in determining how to share a common wireless medium. It is noted that according to various embodiments of the invention the disclosed methods and devices can be applied in networks that utilize a distributed media access control scheme but differ from ultra wideband wireless networks.

The transmission conditions can occur very rapidly. Typically, multiple transmission characteristic changes occur during a single super-frame.

The method facilitates multiple transmission characteristic update during a single super-frame. The amount of updates can equal the amount of acknowledgement frames sent during a single super-frame but this is not necessarily so.

According to an embodiment of the invention a relatively rapid rate of transmission of link feedback information facilitates relatively fast alteration of bit rate, packet sizes, and/or power level, thus the method and device can perform adjustments before link condition changes cause a frame loss during reception.

According to an embodiment of the invention a reception of one or more information frame is acknowledged by sending link feedback information. This information can be used to modify the bit rate and/or the transmission power level of the next information frame.

According to an embodiment of the invention the amount of link feedback information can be limited, in order to reduce link feedback information overhead. Thus, link feedback information can be sent if a certain event occurred (for example a transmission level change exceeds a certain threshold). According to another embodiment of the invention different types of link feedback information are transmitted in different transmissions.

According to yet a further embodiment of the invention the link feedback information is transmitted in response to a reception of only some of the received information frames.

For convenience of explanation it was assumed that link feedback information is included within an acknowledgement frame. It is noted that the invention can be applied to cases where it is not a part of the acknowledgement frame. For example, it can be spaced apart from the acknowledgement frame, and it can be sent instead of the acknowledgement frame.

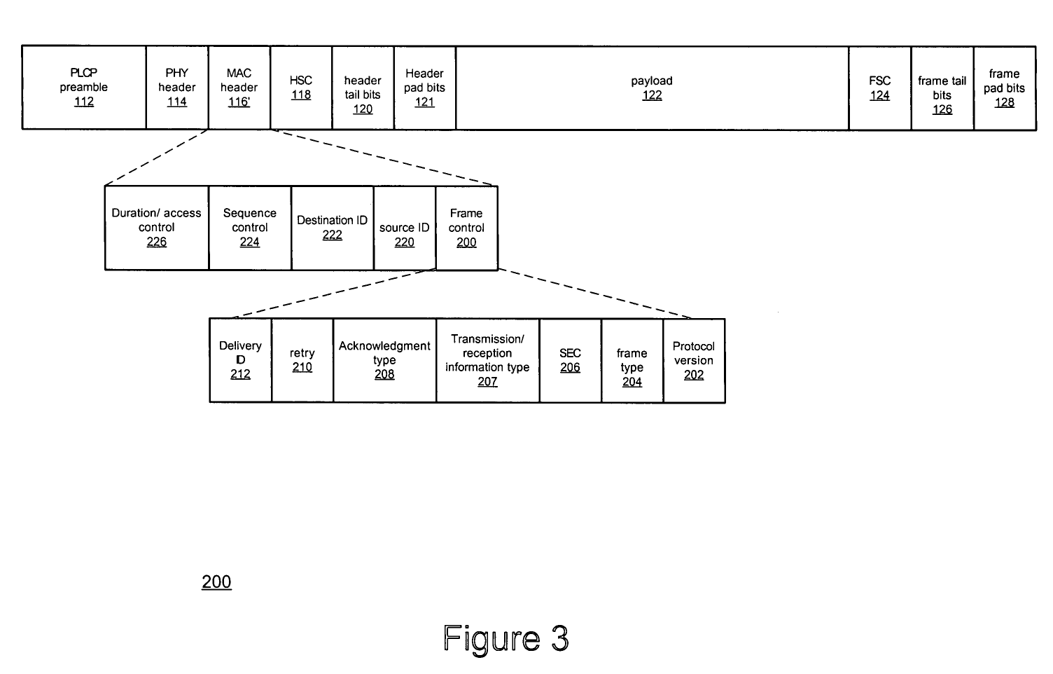

FIG. 3 illustrates an information frame 200 as well as various portions of information frame 200, according to various embodiments of the invention.

The information frame 200 includes a physical layer convergence procedure (PLCP) preamble 112, a PHY layer header 114, a MAC layer header 116, a header check sequence field (HCS) 118, header tail bits 120, header pad bits 121, payload 122, a frame check sequence field (FCS) 124, frame tail bits 126 and pad bits 128.

The information frame 200 includes MAC layer fields such as fields 116, 118, and 124. Information frame 200 also includes various PHY layer fields, such as fields 112, 114, 120, 121, 126 and 128. The payload 122 usually includes one or more MAC layer frames or frames of a upper communication protocol layer, such as an application layer.

The PLCP preamble 112 includes a packet and frame synchronization sequences that are followed by a channel estimation sequence. The PLCP preamble assists the receiver, among other things, to estimate the properties of the wireless medium. MBOA proposes two possible PLCP preambles—a short PLCP preamble and a long PLCP preamble. The long PLCP preamble is used at low bit rates. At high bit rates a first frame includes the long PLCP preamble while the remaining frames may include the short PLCP preamble.

The PHY layer header 114 includes information about the type of modulation, the coding rate and the spreading factor used during the transmission of the information, the length of the frame payload and scrambling data information.

The MAC layer header 116 includes a frame control field 201, source and destination identification fields 220 and 222, sequence control fields 224 and duration/access method fields 226. The frame control field 220 includes a protocol version field 202, a frame type field 204 (indicates if a frame is a beacon frame, control frame, command frame, data frame and the like), a SEC field 206 (indicated if the frame is encrypted), an acknowledge policy field 208 (no acknowledge, immediate acknowledge, burst acknowledge or burst acknowledge request), a retry field 210 (indicates if the frame is re-transmitted), and delivery ID field 212. An immediate acknowledge requires to send an acknowledge frame response after the recipient of the information frame. The burst acknowledge indicates to send an acknowledgement frame after a group of frames (frame burst) was successfully received.

The destination identification field 220 indicates the identity of intended receivers and may indicate that the transmission is multicast. In case of broadcast the identity of recipients is not necessarily known in advance.

The header tail bits 120 as well as the frame tail bits 126 are set to zero, thus allowing a convolutional encoder within the receiver to return to a “zero state” and improve its error probability. The header tail bits 120 (the frame tail bits 126) are followed by header pad bits 121 (frame pad bits 128) in order to align the information stream on an OFDM interleaver boundaries.

The payload is usually between one byte and 4096 bytes long. When a transmission or reception error occurs the whole frame is re-transmitted.

According to various embodiments of the invention information frame 200 includes at least one field that defines the link feedback information to be sent by the receiving device. This at least one field can also indicate the manner (timing, regularity and the like) of transmitting the link feedback information.

FIG. 3 illustrates a link feedback information type field 207 that can indicate the type of link feedback information that the receiving device has to transmit. It is noted that such a field can be required when different types of link feedback information can be transmitted.

The link feedback information can include: signal to noise ratio, a required bit rate, a transmission level, a bit rate change, a transmission level change, a delay between frames, and the like.

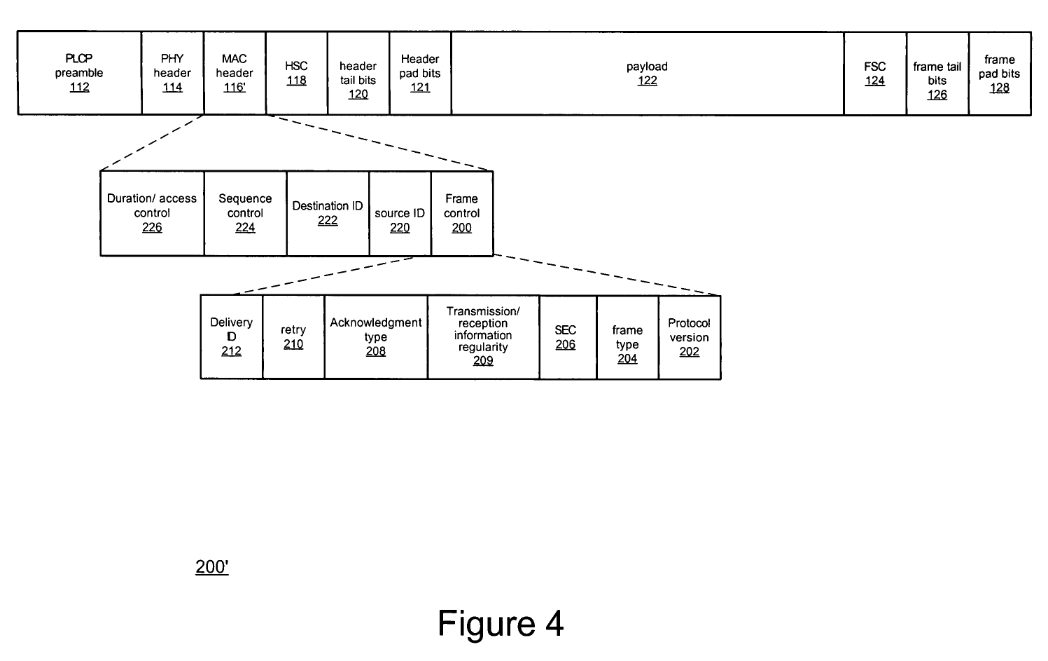

Yet according to an embodiment of the invention the devices can agree upon the regularity of transmission of the link feedback information. For example, a dedicated field (such as link feedback information regularity field 209 of FIG. 4) can be allocated for determining the ratio between the number of acknowledgements frames that do not include link feedback information and between the number of acknowledgement frames that include link feedback information.

If, for example, an immediate acknowledgement scheme is selected then the devices can agree that link feedback information is sent within each K acknowledgement frames (whereas K is a positive integer). Conveniently, K is smaller that the number of frames that form a single super-frame such as TDMA frame 30.

According to yet another embodiment of the invention a device can transmit link feedback information only when a certain event occurs—when a certain characteristic exceeds a certain threshold. For example, if the transmission level has to be altered by more than a predefined power threshold then the receiver transmits link feedback information. The acknowledgement frame can include a flag that indicates whether the acknowledgment frame includes link feedback information.

This transmission scheme, as well as power thresholds and/or SNR thresholds, required transmission bit-rate changes/adjustments, and the like can also be included within information frame 200. There are various manners to include this type of information, including allocating dedicated fields, and the like.

Yet for another embodiment of the invention, the devices can monitor changes in the transmission characteristics and accordingly alter the transmission regularity of the link feedback information. The changes can be monitored by one or mode devices and shared between the devices, but this is not necessarily so.

According to yet another embodiment of the invention different link feedback information types can be included in different acknowledgement frames. For example, if there are various different fields of link feedback information some fields can be sent in one frame while other fields can be sent in another frame.

The transmission/reception information types that are transmitted in different acknowledgement frames can be predetermined, can be indicated by a dedicated field or can be selected by transmitting device, according to various parameters. For example, the devices of a certain ultra wideband wireless network can agree upon the transmission information fields that are sent in every frame.

A device can decide to transmit only a portion of the transmission/reception information. It can select, for example, to transmit the most important type of link feedback information, the most effecting type of link feedback information or the link feedback information that has changed the most.

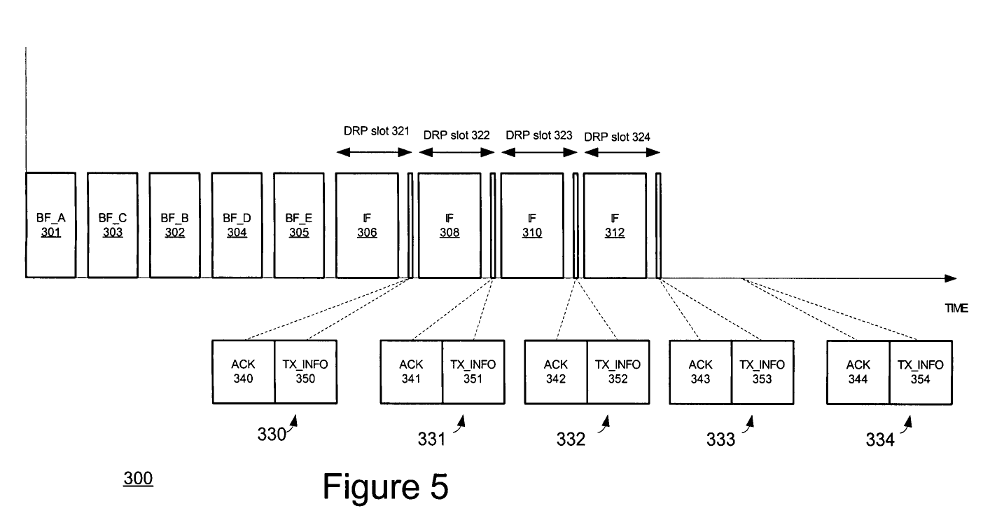

FIGS. 5-7 illustrate various frame sequences, according to various embodiments of the invention.

FIG. 5 illustrates a frame sequence 300 that includes multiple acknowledgement frames 330-334. Each acknowledgement frame includes at least one acknowledgement field and at least one link feedback information field.

Various acknowledgement information fields are known in the art. Some were defined in the MBOA wireless medium access control (MAC) specification for high rate wireless personal area networks (WPANS), draft 0.72, which is incorporated herein by reference. These field include, for example, a protocol version field, a frame type field, a SEC field, an ACK policy (acknowledgement type) field, a retray field, an access method (DRP or non-DRP) field, a transmitter and receiver ID field, a sequence control field, a duration field and the like. It is noted that one or more of these fields can be used to convey link feedback information. It is further noted that if a burst acknowledgement policy is applied then the acknowledgement frame can include additional fields such as a buffer size field and a burst size field that indicate the available buffer space (in octets) and the maximal acceptable size of a next burst in units of frames.

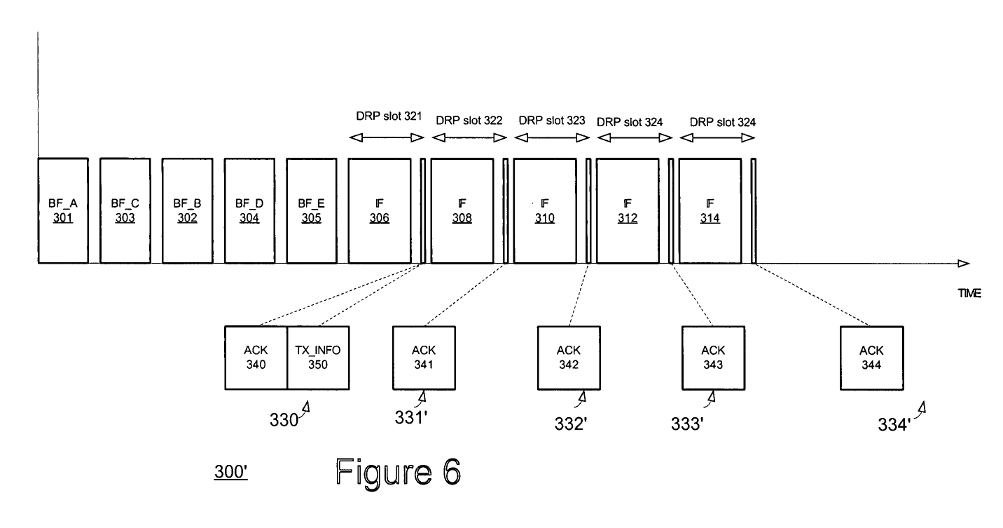

FIG. 6 illustrates a frame sequence 300′ that includes multiple acknowledgement frames 330, 331′, 332′, 333′ and 334′. Only one fifth of the acknowledgement frames includes one or more link feedback information fields. In this case K equals five. Conveniently one super-frame includes much more than five frames and multiple acknowledgement frames that include link feedback information are transmitted during a single super-frame.

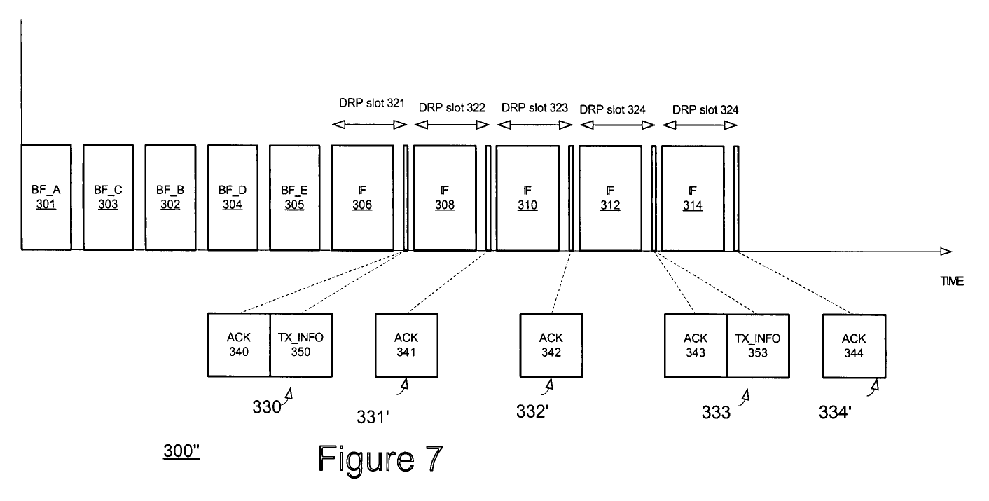

FIG. 7 illustrates a frame sequence 300″ that includes multiple acknowledgement frames 330, 331′, 332′, 333 and 334′. It is assumed that link feedback information is transmitted once a predefined event occurs. It is also assumed that the first and fourth acknowledgment frames (330, 333) include link feedback information.

Referring back to FIG. 5. The frame sequence 300 starts by five beacon frames beacon frames (BF) 301, 303, 302, 304 and 305, that are transmitted from each of the components A-E of network 10.

The beacon frames are followed by a first information frame (IF) 306 that is transmitted from a first device (for example device A 11) of network 10 to another device (for example device B 12). The first IF 306 is followed by a first acknowledgement frame 330 that includes at least one acknowledgement fields, such as ACK field 340, as well as one or more link feedback information fields, such as TX_INFO field 350.

The first information frame 306 and the first acknowledgement frame 330 are transmitted during a first DRP slot 321.

The first DRP period 321 is followed by a second DRP period 322 during which a second information frame 308 and a second acknowledgement frame 331 are transmitted. The second DRP period 322 is followed by a third DRP period 323 during which a third information frame 310 and a third acknowledgement frame 332 are transmitted. The third DRP period 323 is followed by a fourth DRP period 324 during which a fourth information frame 312 and a fourth acknowledgement frame 333 are transmitted. The fourth DRP period 324 is followed by a fifth DRP period 325 during which a fifth information frame 314 and a fifth acknowledgement frame 334 are transmitted.

It is noted that during each DRP period multiple frames as well as acknowledgement frames can be transmitted. For convenience of explanation these DRP periods are illustrated as including a single frame and an acknowledgement frame. In practice, a single DRP period may include multiple frames transmitted.

Each acknowledgement frame out of frames 330-331 includes at least one acknowledgement field and a link feedback information field. It is noted that different link feedback information fields can convey different types of link feedback information. For example, the first, third and fifth acknowledgement frames 330, 332 and 334 can include a desired bit rate and the other acknowledgement frames 331 and 333 can include a desired transmission power level change.

In FIG. 6 only acknowledgement frame 330 includes both one or more acknowledgement fields 340 and one or more link feedback information fields 350. The other acknowledgement frames (331′, 332′, 333′ and 334′) include only one or more acknowledgement fields.

In FIG. 7 only acknowledgement frames 330 and 333 include both one or more acknowledgement fields 340 and 343 accordingly, and one or more link feedback information fields 350 and 353 accordingly. The other acknowledgement frames (331′, 332′ and 334′) include only one or more acknowledgement fields. It is noted that each frame out of acknowledgement frames 330 and 333 can include multiple types

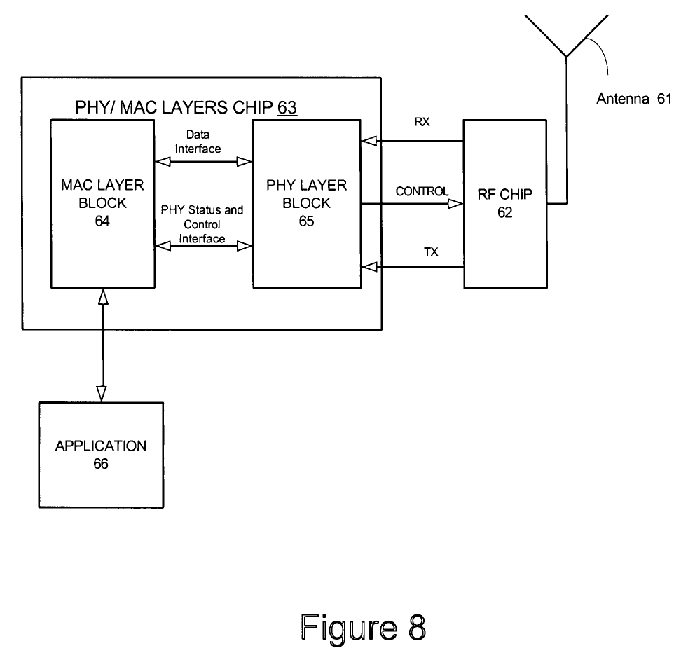

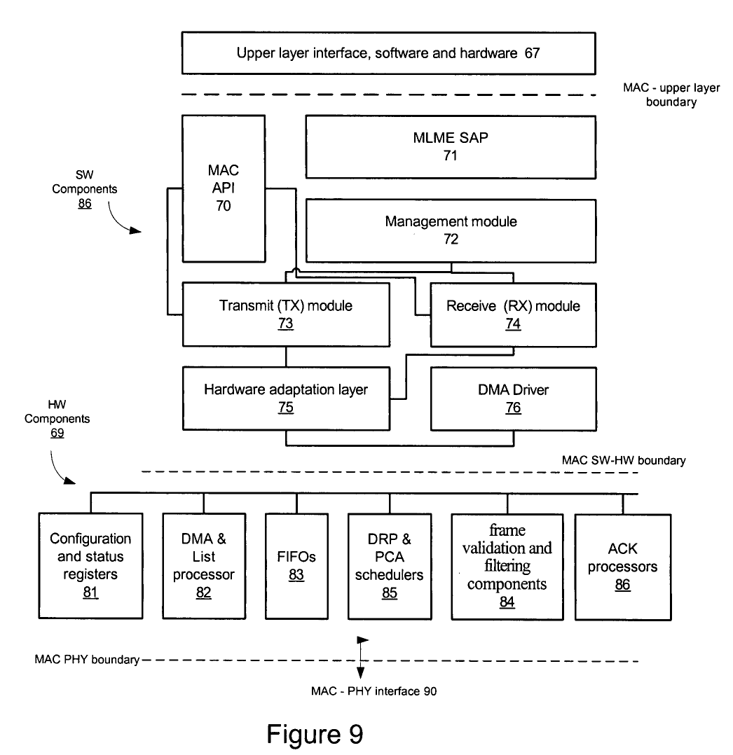

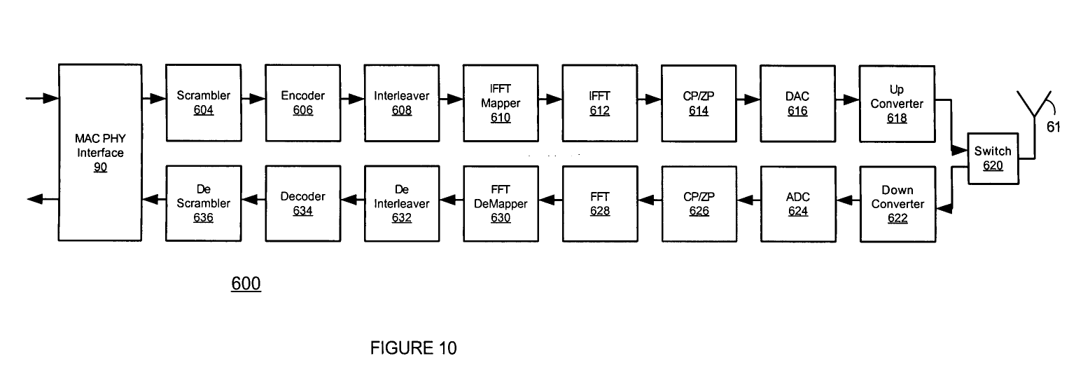

FIG. 8 illustrates an ultra wideband device 60, according to an embodiment of the invention. FIG. 9 described in greater details multiple components of device 60, according to an embodiment of the invention and FIG. 10 illustrates multiple components of the PHY layer of device 60, according to an embodiment of the invention.

Conveniently, device 60 is a part of an ultra wideband wireless network and has a communication protocol stack that includes at least a PHY layer and a MAC layer. The MAC layer of such devices controls the access to ultra wideband wireless medium and is referred to ultra wideband wireless medium access control.

Examples of devices that have a PHY layer and/or MAC layers are illustrated in the following U.S. patent applications, all being incorporated herein by reference: U.S. patent application Ser. No. 10/389,789 filed on Mar. 10, 2003; U.S. patent application Ser. No. 10/603,372 filed on Jun. 25, 2003; and U.S. patent application Ser. Nos. 11/043,279, 11/043,253, 11/043,467, 11/043,457, 11/043,646 and 11/043,456.

Device 60 includes a multi-layers receiver and a multi-layered transmitter. The multi-layered components support a multiple layer communication stack. A first configuration of device 60 includes a frame convergence sub-layer, a MAC layer, a PHY layer as well as MAC SAP, PHY SAP, frame convergence sub-layer SAP and a device management entity can also be utilized.

Wisair Inc. of Tel Aviv Israel manufactures a chip set that includes a Radio Frequency PHY layer chip and a Base-Band PHY layer chip. These chips can be connected in one end to a RF antenna and on the other hand can be connected to or may include a MAC layer circuitry.

Device 60 that is capable of wireless transmission and reception, according to an embodiment of the invention.

Conveniently, device 60 supports a multi-layer communication protocol stack that includes a PHY layer and a MAC layer. MAC layer hardware and/or software components form an ultra wideband wireless medium access controller, that is adapted to participate in a distributed media access control scheme that allocates at least one timeslot for a transmission of information from a first device to a group of peer devices and for a transmission of acknowledgement massages from the peer devices of the group. PHY layer hardware and/or software components form a transmission circuitry adapted to transmit the information in response to the allocation.

Device 60 includes antenna 61 that is connected to a RF chip 62. RF chip 62 is connected to a MAC/PHY layers chip 63 that includes a PRY layer block 63 and a MAC layer block 64. The MAC/PHY layers chip 63 is connected to an application entity 66 that provides it with information to be eventually transmitted (TX) and also provides the application 66 with information received (RX) by antenna 61 and processed by PHY and MAC layers blocks 68 and 69 of FIG. 9.

Typically, the MAC layer block 64 controls the PHY layer block using a PHY status and control interface. The MAC and PHY layers exchange information (denoted TX and RX) using PHY-MAC interface 90. The RF chip 62 provides to the PHY layer block 63 received information that is conveniently down-converted to base band frequency. The RF chip 62 receives from the PHY layer block 63 information to be transmitted as well as RF control signals. The application 66 is connected to the MAC/PHY layers chip 63 by a high speed I/O interface.

FIG. 9 illustrates various hardware and software components of the MAC/PHY layers chip 63, according to an embodiment of the invention.

The Upper Layer IF block 64 of the MAC/PHY layers chip 63 includes hardware components (collectively denoted 69) and software components (collectively denoted 68). These components include interfaces to the PHY layer (MAC-PHY interface 90) and to the application (or higher layer components).

The hardware components 69 includes configuration and status registers 81, Direct Memory Access controller and list processor 82, First In First Out (FIFO) stacks 83 and frame validation and filtering components 84, DRP and PCA slots schedulers 85, ACK processors 86, and MAC-PHY internal interface 87.

The software components 68 includes a management module 72, transmit module 73, receive module 74, hardware adaptation layer 75, DMA drivers 76, MAC layer management entity (MLME) service access point (SAP) 71, MACS API 70 and the like.

These software and hardware components are capable of performing various operations and provide various services such as: providing an interface to various layers, filtering and routing of specific application packets sent to MAC data queues or provided by these queues, performing information and/or frame processing, and the like.

The routing can be responsive to various parameters such as the destinations of the packets, the Quality of Service characteristics associated with the packets, and the like.

The processing of information along a transmission path may include: forming the MAC packet itself, including MAC header formation, aggregation of packets into a bigger PHY PDU for better efficiency, fragmentation of packets for better error rate performance, PHY rate adaptation, implementation of acknowledgements policies, and the like.

The processing of information along a reception path may include de-aggregation and/or de-fragmentation of incoming packets, implementation of acknowledgment policies and the like.

The hardware components are capable of transferring data between MAC software queues and MAC hardware (both TX and RX), scheduling of beacons slots, scheduling of DRP and PCA access slots, validation and filtering (according to destination address) of incoming frames, encryption/decryption operations, low-level acknowledgement processing (both in the TX path and in the RX path),

Device 60 can be a simple device or even a complex device such as but not limited to a multimedia server that is adapted to transmit information frames of different types to multiple devices. It can, for example transmit Streaming data, like voice, Video, Game applications, etc.) data files during DRP slots, and while PCA slots transmits video over IP frames, download MP3 files, download MPEG-2 files, and stream or download MPEG-4 streams.

FIG. 10 illustrates various PHY layer components 600, according to an embodiment of the invention. The PHY layer components 600 include a transmission path and a reception path.

The PHY layer transmission path includes the following sequence of components: scrambler 604, encoder 606, interleaver 608, IFFT mapper 610, IFFT converter 612, CP/ZP block 614, digital to analog converter (DAC) 616, an up-converter 618, receive/transmit switch 620 and antenna 61.

The PHY layer reception path includes the following sequence of components: antenna 61, receive/transmit switch 620, down-converter 622, analog to digital converter (ADC) 624, CP/ZP block 626, FFT converter 628, FFT de-mapper 630, de-interleaver 632, decoder 634 and descrambler 636. All these components are well known in the art and do not require additional explanation.

According to an embodiment of the invention the ADC 624 provides a digital number representative of the received analog symbol, and the CP/ZP block 626 can calculate the transmission characteristics, such as a signal to noise ratio, by comparing between the received symbol and an expected symbol. The expected symbol is known in advance and is determined once the modulation scheme is determined. For example a 64-QAM modulation include sixty four expected symbols.

The transmission characteristics can be calculated in response to a reception or one or more symbols. A frame include multiple symbols and various statistical operations can be applied in order to provide a transmission characteristic.

Method and device for determining various transmission characteristics (such as bit rate, power level and the like) in response to received signals are known in the art. Device 60 can apply these prior art method and can include components known in the art for performing data rate adaptation, packet size adjustments and/or power level adaptation.

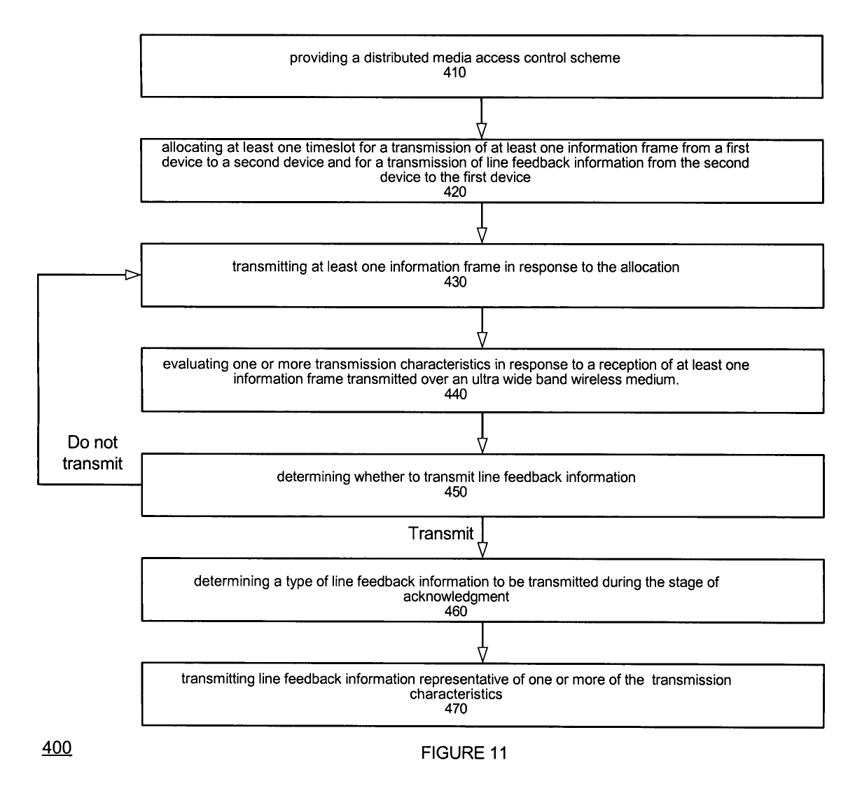

FIG. 11 is a flow chart of method 400 for dynamically updating transmission characteristics, according to an embodiment of the invention.

Method 400 starts by optional stage 410 of providing a distributed media access control scheme. Conveniently, stage 410 includes scheduling a transmission and a reception of beacon frames, allocating PCA slots and DRP slots and the like. Conveniently, the DRP slots are coordinated between devices that belong to the same network and allow devices to reserve these slots in advance. During the PCA slots devices that belong to the network compete for access based upon their transmission priority. It is noted that the allocation of media access time slots is dynamic and may change from one TDMA frame to another.

Stage 410 can be repeated during the execution of the other stages of method 400. Thus, various slots can be allocated before and after a multicast transmission is requested and scheduled. Typically, the ultra wideband wireless network does not include a central media access controller and the various peer devices that form this network exchange signals in order to allocate timeslots (grant access to the wireless medium).

According to various embodiments of the invention method 400 can be applied by other networks, such as but not limited to networks that are not ultra wideband networks. These networks can apply a distributed media access control scheme.

Conveniently, stage 410 includes determining an order of beacon frames that are transmitted by the peer devices. Typically, before a device joins a network is tries to detect existing beacon frames and if received it transmits its own beacon frame such as not to disrupt the existing beacon frames.

Stage 410 is followed by stage 420 of allocating at least one timeslot for a transmission of at least one information frame from a first device to a second device and for a transmission of link feedback information from the second device to the first device. Conveniently, during a single super-frame multiple information frames are transmitted between peer devices and multiple link feedback information is also transmitted between peer devices.

Stage 420 is followed by stage 430 of transmitting at least one information frame in response to the allocation. It is assumed that an various information frames, such as the frames of sequences 300, 300′ and 300″ can be transmitted, but other frame sequences can also be transmitted.

Stage 430 is followed by stage 440 of evaluating one or more transmission characteristics in response to a reception of at least one information frame transmitted over an ultra wideband wireless medium. Conveniently, the evaluating includes calculating the signal to noise ratio of at least one received symbol in response to a difference between the at least one received symbol and an expected symbol.

Stage 440 is followed by optional stage 450 of determining whether to transmit link feedback information. According to one aspect of the invention the determination is responsive to at least one value of a transmission characteristic. According to another embodiment of the invention the determination is responsive to at least one value of a current transmission characteristic value and a previous transmission characteristic value. According to yet a further embodiment of the invention the determination is responsive to a predefined policy. For example only some acknowledgement frames can include link feedback information.

If stage 450 decided not to transmit link feedback information then stage 450 can be followed by either one of stages 420, 430 or 440. Else, stage 450 is followed by stage 460 of determining a type of link feedback information to be transmitted during the stage of acknowledgment. Conveniently, different acknowledgement frames include different types of link feedback information. For example one acknowledgement frame can include transmission power level information while another acknowledgement frame can include bit rate information.

Stage 460 is followed by stage 470 of transmitting link feedback information and acknowledgement information in response to the reception of at least one information frame. The link feedback information is representative of the transmission characteristics. According to an embodiment of the invention stage 470 includes acknowledging a reception of one or more information frames by transmitting link feedback information.

Conveniently, either one of stages 450, 460 and 470 is repeated multiple time within a transmission period of a single super-frame.

It is noted that multiple iterations of stages 430-370 can occur during a transmission period of a single super-frame. For example, referring to FIGS. 5-7 a transmission of a single information frame (306, 308, 310, 312 and 314) can be followed by a transmission of link feedback information.

It is noted that the acknowledgement information and/or the link feedback information can be processed in order to determine a continuation of transmission of future frames, a re-transmission of one or more frames, a transmission characteristic change, an acknowledgement policy change, information frame alteration (by fragmentation or aggregation), altering the identity of the recipients and the like.

It is noted that method 400 facilitates a transmission of multiple information frames during multiple time frames. The identity of the devices that belong to the group can change over time, and method 400 is responsive to said change. Thus, the amount of acknowledgement frames and the identity of intended acknowledging devices may change.

It will be apparent to those skilled in the art that the disclosed subject matter may be modified in numerous ways and may assume many embodiments other then the preferred form specifically set out and described above. For example, the amount of access units can differ from the amount of queues, the amount of queues and the amount of transmission priorities can vary. It is noted that each of the mentioned above circuitries can be applied by hardware, software, middleware or a combination of the above.

Accordingly, the above disclosed subject matter is to be considered illustrative and not restrictive, and to the maximum extent allowed by law, it is intended by the appended claims to cover all such modifications and other embodiments, which fall within the true spirit and scope of the present invention.

The scope of the invention is to be determined by the broadest permissible interpretation of the following claims and their equivalents rather then the foregoing detailed description.

We claim:

1. A method for dynamically updating transmission characteristics, the method comprising: evaluating at least one transmission characteristic in response to a reception of at least one information frame being transmitted over an ultra wideband wireless medium; and transmitting link feedback information and acknowledgement information in response to the reception of the at least one information frame.

2. The method according to claim 1 wherein the stage of transmitting is repeated multiple time within a single super frame.

3. The method according to claim 1 further comprising determining whether to transmit link feedback information in response to at least one value of a transmission characteristic.

4. The method according to claim 1 further comprising determining whether to transmit link feedback information in response to at least one value of a current transmission characteristic value and a previous transmission characteristic value.

5. The method according to claim 1 further comprising determining a type of link feedback information to be transmitted during the stage of acknowledgment.

6. The method according to claim 1 wherein different acknowledgement frames comprise different types of link feedback information.

7. The method according to claim 1 wherein the evaluating comprises calculating a signal to noise ratio of at least one received symbol in response to a difference between the at least one received symbol and an expected symbol.

8. The method according to claim 1 wherein the link feedback information comprises transmission level change.

9. A device comprising: a receiver adapted to evaluate at least one transmission characteristic in response to a reception of at least one information frame being transmitted over an ultra wideband wireless medium; and transmitter adapted to transmit link feedback information and acknowledgement information in response to the reception of the at least one information frame.

10. The device accord to claim 9 wherein the transmitter is adapted to transmit link feedback information multiple times during a single super frame.

11. The device accord to claim 9 further adapted to determine whether to transmit link feedback information in response to at least one value of a transmission characteristic.

12. The device accord to claim 9 further adapted to determine whether to transmit link feedback information in response to at least one value of a current transmission characteristic value and a previous transmission characteristic value.

13. The device accord to claim 9 further adapted to determine a type of link feedback information to be transmitted during the of acknowledgment.

14. The device accord to claim 9 wherein different acknowledgement frames comprise different types of link feedback information.

15. The device accord to claim 9 further adapted to calculate a signal to noise ratio of at least one received symbol in response to a difference between the at least one received symbol and an expected symbol.

16. The device accord to claim 9 wherein the link feedback information comprises transmission level change.

17. A computer readable medium having code embodied therein for causing an electronic device to perform the stages of: evaluating at least one transmission characteristic in response to a reception of at least one information frame being transmitted over an ultra wideband wireless medium; and transmitting link feedback information and acknowledgement information in response to the reception of the at least one information frame.
